(19) United States
(12) Patent Application Publication
(10) Pub. No.: US 2021/0181012 A1
(43) Pub. Date: Jun. 17, 2021

(54) ELECTRONIC DEVICE, CHARGE PORT AND PORTABLE CRADLE

(71) Applicant: LAMBO IP LIMITED, Sheung Wan (HK)

(72) Inventor: Florian Jurgen Simmendinger, Central (HK)

(21) Appl. No.: 17/259,748

(22) PCT Filed: Jul. 25, 2018
(86) PCT No.: PCT/CN2018/097021

§ 371 Date: Jan. 12, 2021

(51) Int. Cl. G01H 1/12

(52) U.S. Cl. CPC G01H 1/12

(57) ABSTRACT

An electronic device comprising: a vibration sensor arranged to detect and measure a vibration emitted from a vibration source; and a housing arranged to house the vibration sensor; wherein the housing includes an engagement mechanism to engage the housing to a portable cradle.

### TECHNICAL FIELD

The present invention relates to an electronic device, and particularly, although not exclusively, to an electronic device arranged to operate with a musical instrument to provide music related functions and can also be adapted to be worn as a wearable device.

### BACKGROUND

Musicians and users of musical instruments are often monitoring the condition and characteristics of their instruments as the music that are emitted from the instrument can be substantially affected by these conditions and characteristics. In turn, it is common for musicians to tune, manipulate or otherwise adjust their musical instruments regularly during practice, performance or casual jamming.

Electronic tuners, such as guitar tuners, are used by musicians to tune various instruments. However, although these devices are effective at helping musicians to tune their instruments, these tuners are very limiting in their functionalities. Furthermore, these tuners may also be cumbersome and do not integrate well with musicians and their equipment resulting in many musicians avoiding or minimizing the use of their tuners.

### SUMMARY OF THE INVENTION

In accordance with a first aspect of the present invention, there is provided an electronic device comprising:
a vibration sensor arranged to detect and measure a vibration emitted from a vibration source;
a housing arranged to house the vibration sensor;
   wherein the housing includes an engagement mechanism to engage the housing to a portable cradle.

In an embodiment of the first aspect, the portable cradle is arranged to be engaged with a user or an object.

In an embodiment of the first aspect, the portable cradle is arranged to be engaged with a limb of the user.

In an embodiment of the first aspect, the portable cradle is arranged to be worn by the user.

In an embodiment of the first aspect, the portable cradle includes at least two adjustable straps detachably connected thereto.

In an embodiment of the first aspect, the at least two adjustable straps are symmetrical bands.

In an embodiment of the first aspect, the portable cradle includes at least one protrusion to engage the engagement mechanism of the housing.

In an embodiment of the first aspect, the portable cradle includes at least one magnet to engage the engagement mechanism of the housing.

In an embodiment of the first aspect, the engagement mechanism includes a rig mechanism, at least one magnet or a combination thereof for engaging the housing to the portable cradle.

In an embodiment of the first aspect, the rig mechanism includes at least one hallow coupling member for engaging the housing to the portable cradle.

In an embodiment of the first aspect, the at least one hallow coupling member is a bayonet sleeve.

In an embodiment of the first aspect, the housing is releasably engaged to the portable cradle through a twistable action between the rig mechanism of the housing and the at least one protrusion of the portable cradle.

In an embodiment of the first aspect, the housing is releasably engaged to the portable cradle through a magnetic interaction between the at least one magnet of the housing and the at least one magnet of the portable cradle.

In an embodiment of the first aspect, the housing is releasably engaged to the portable cradle through a combination of the twistable action in accordance with the first aspect and the magnetic interaction in accordance with the first aspect.

In an embodiment of the first aspect, the device further includes at least two pieces of magnet being arranged within the housing.

In an embodiment of the first aspect, the at least two pieces of magnet are arranged to releasably secure the device to a metallic portion of a musical instrument.

In an embodiment of the first aspect, the at least two pieces of magnet are further arranged to form a portion of a charging port of the device.

In an embodiment of the first aspect, at least one of the magnets is arranged with the north pole facing outside and at least one of the magnets is arranged with the south pole facing outside.

In an embodiment of the first aspect, the vibration sensor is a transducer.

In an embodiment of the first aspect, the transducer is an electromechanical transducer.

In an embodiment of the first aspect, the vibration is a musical note.

In an embodiment of the first aspect, the vibration source is a musical instrument.

In an embodiment of the first aspect, the device is powered by a rechargeable lithium battery.

In an embodiment of the first aspect, the device further includes at least one indicator to reflect the accuracy of the detection and measurement.

In an embodiment of the first aspect, the indicator is a color LED.

In an embodiment of the first aspect, the device is further arranged to measure a sound level of the surroundings.

In an embodiment of the first aspect, the device is further arranged to wirelessly communicate with at least one external electronic device to perform at least one of the followings:
receiving notification from the at least one external electronic device;
selecting time signature, subdivisions, accents, vibration waveforms, and light colors; and
receiving rhythm games from the at least one external electronic device.

In an embodiment of the first aspect, the device is further arranged to display time and perform an alarm.

In an embodiment of the first aspect, the device is further arranged to operate as a metronome.

In an embodiment of the first aspect, the metronome is arranged to be provided by visual means, audio means, tactile means or any one or more thereof.

In an embodiment of the first aspect, the device includes a vibration motor arranged to vibrate at a specific rate.

In an embodiment of the first aspect, the specific rate is determined by a processor.

In an embodiment of the first aspect, the processor is arranged to apply an error correction procedure to measure the vibration emitted from the vibration source.

In an embodiment of the first aspect, the error correction procedure includes the steps of determining the vibrations of the vibration motor and deducting the vibrations from the measured vibrations emitted from the vibration source.

In an embodiment of the first aspect, the device is arranged to perform one or more of the following functions:
selecting time signature, subdivisions, accents, vibration waveforms, and light colors; or
operating rhythm games.

In an embodiment of the first aspect, the device is further arranged to wirelessly communicate with at least one external electronic device to exchange data, signals, notifications, messages or any one or more thereof.

In an embodiment of the first aspect, the device is further arranged to display time.

In accordance with a second aspect of the present invention, there is provided a charge port for an electronic device comprising:
a conductive conduit arrangement arranged to connect a battery with an external power source; and
a magnetic arrangement disposed adjacent to the conductive conduit arrangement; wherein the magnetic arrangement is arranged to assist in the engagement of the external power source to the conductive conduit arrangement.

In an embodiment of the second aspect, the external power source is engaged to the conductive conduit arrangement via a socket head having a ferromagnetic surface.

In an embodiment of the second aspect, the magnetic arrangement includes a pair of magnets.

In an embodiment of the second aspect, the socket head has a pair of magnetic members to complement the pair of magnets of the magnetic arrangement.

In an embodiment of the second aspect, the pair of magnets of the magnetic arrangement is arranged with a predetermined polarity configuration to complement the magnetic members of the socket head.

In an embodiment of the second aspect, the charge port is used to engage the electronic device to a or ferromagnetic work surface, equipment or musical instrument.

In an embodiment of the second aspect, the charge port uses the magnetic arrangement to magnetically engage the electronic device to the work surface, equipment or musical instrument.

In accordance with a third aspect of the present invention, there is provided a portable cradle for an electronic device comprising:
a cavity arranged to receive the electronic device, wherein the cavity includes a locking mechanism arranged to removably engage or disengage with the electronic device; and
engagement means arranged to engage the cradle to an object or person.

In an embodiment of the third aspect, the engagement means include one or more lugs, each of the lugs arranged to receive a strap for wearing or securing with the object or person.

In an embodiment of the third aspect, the locking mechanism is a slot arranged to receive a protruding member of the electronic device to engage the device to the cradle.

In an embodiment of the third aspect, the slot and the protruding member are locked by rotating the protruding member around a shoulder of the slot.

In an embodiment of the third aspect, the slot and the protruding member are unlocked by rotating the protruding member around the shoulder of the slot in a direction opposite to locking the slot and the protruding member.

In an embodiment of the third aspect, the cavity includes one or more magnetic members arranged to attract a ferromagnetic surface of the electronic device to engage the cradle with the electronic device.

In an embodiment of the third aspect, the cavity and the electronic device includes a snap-fit arrangement arranged to engage the cradle to the electronic device.

In accordance with a four aspect of the present invention, there is provided an electronic device comprising:
a vibration motor arranged to vibrate at a specific rate; and
a housing arranged to house the vibration motor;

wherein the housing includes an engagement mechanism to engage the housing to a portable cradle.

In accordance with a fifth aspect of the present invention, there is provided an electronic device comprising:
a processor arranged to provide sound, music or smart watch functions; and
a housing arranged to house the vibration motor; wherein the housing includes an engagement mechanism to engage the housing to a portable cradle.

### BRIEF DESCRIPTION OF THE DRAWINGS

Embodiments of the present invention will now be described, by way of example, with reference to the accompanying drawings in which:

FIG. 1A is a perspective view of the electronic device in accordance with one embodiment of the present invention;

FIG. 1B is another perspective view of the electronic device of FIG. 1A;

FIG. 1C is a perspective view of the electronic device and the cradle arrangement in accordance with one embodiment of the present invention;

FIG. 2 is a top perspective view of the electronic device in accordance with one embodiment of the present invention, with its interface crystal removed;

FIG. 3A is a top perspective view of the electronic device of FIG. 2 with the screens and light layout being removed;

FIG. 3B is a bottom perspective view of the electronic device of FIG. 3A with the bottom cover being removed;

FIG. 4A is a side view of the electronic device in accordance with one embodiment of the present invention;

FIG. 4B is a bottom perspective view of the electronic device in accordance with one embodiment of the present invention;

FIG. 5A is a schematic diagram illustrating an engagement mechanism between the electronic device and the cradle arrangement in accordance with one embodiment of the invention;

FIG. 5B is a bottom perspective view of the electronic device in accordance with one embodiment of the invention;

FIG. 5C is a perspective view of the cradle arrangement arranged to complement the electronic device of FIG. 5B;

FIG. 6A is an example screen interface of the electronic device in accordance with one embodiment of the invention showing the watch function of the device;

FIG. 6B is an example screen interface of the electronic device in accordance with one embodiment of the invention showing the metronome function of the device;

FIG. 6C is an example screen interface of the electronic device in accordance with one embodiment of the invention showing the tuner function of the device;

FIG. 6D is an example screen interface of the electronic device in accordance with one embodiment of the invention showing the sound level meter function of the device;

FIG. 6E is an example screen interface of the electronic device in accordance with one embodiment of the invention showing the alarm function of the device;

FIG. 6F is an example screen interface of the electronic device in accordance with one embodiment of the invention showing the stopwatch function of the device;

FIG. 6G is an example screen interface of the electronic device in accordance with one embodiment of the invention showing the timer function of the device;

FIG. 6H is an example screen interface of the electronic device in accordance with one embodiment of the invention showing the screen rotation function of the device;

### DETAILED DESCRIPTION OF THE PREFERRED EMBODIMENT

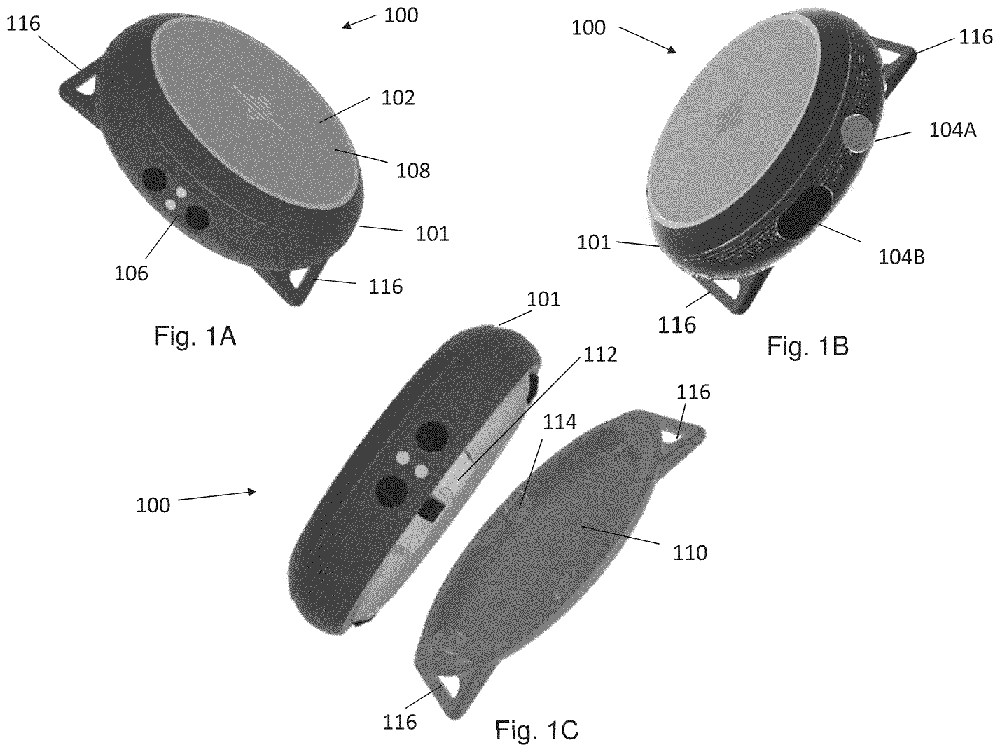

Referring to FIGS. 1A to 1C, there is illustrated an example embodiment of an electronic device 100 comprising: a vibration sensor arranged to detect and measure a vibration emitted from a vibration source; and a housing 101 arranged to house the vibration sensor; wherein the housing 101 includes an engagement mechanism to engage the housing 101 to a portable cradle 110.

In this embodiment, the electronic device 100 is a user device arranged to provide a number of electronic and computational functions to a user. Such users may include, without limitations, musicians or musical instrument tuners or any other users interested in music, sound or the study and observations of vibrations, simple harmonic motions or oscillations. In this embodiment, the electronic device 100 is implemented to be around the size of a watch or wrist computer and may be suitable for placement near a sound or vibration source, such as a musical instrument, or engaged to the sound or vibration source for use. Alternatively, the device 100 may also be placed in a portable cradle 110 so as to be portable or become a wearable device for a user and function as a smart watch for the user.

Preferably, a core function provided by the electronic device 100 is to detect and measure vibrations from a musical instrument or other vibration or sound source. Such measurements may include the physical characteristics of the vibration or sound waves, such as direction, amplitude, velocity, wavelength, waveform so as to devise other characteristics such as intensity or frequencies of the vibration. This is particularly useful to musicians as these measurements may assist in the tuning of a musical instrument.

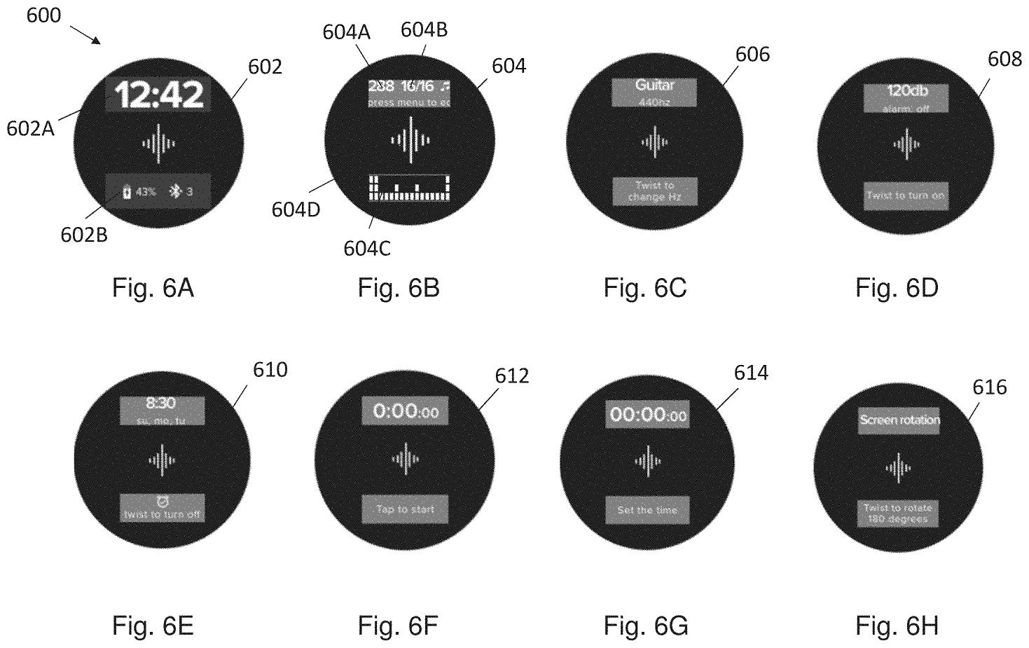

Additionally, the electronic device 100 may also provide a number of other electronic functions such as metronome, music player, sound/music recorder, time, date and alarm function, games and sound level meter functions, which will be explained in further details below with reference to FIGS. 6A to 6H.

As shown in FIGS. 1A to 1C, the electronic device 100 in this example takes the form of a cylindrical body with an interface 102, actuators 104A and 104B, speakers, microphone and a charging port 106. In this example, the cylindrical body is a housing 101 arranged to house the electronic components of the device 100 and may be made from plastic, resin, metal or any suitable materials.

On one side of the housing 101 is the interface 102, which includes a crystal 108 arranged to cover the interface 102. The interface 102 is arranged to provide information to a user and may include visual information, such as by text or graphics.

The device 100 also includes a number of switches (104A, 104B) in the form of buttons to allow for further user inputs to access different functions of the device 100. In some embodiments, the interface 102 may also be adapted to be manipulated by a user and thus may also support a touch screen to detect touch gestures by the user.

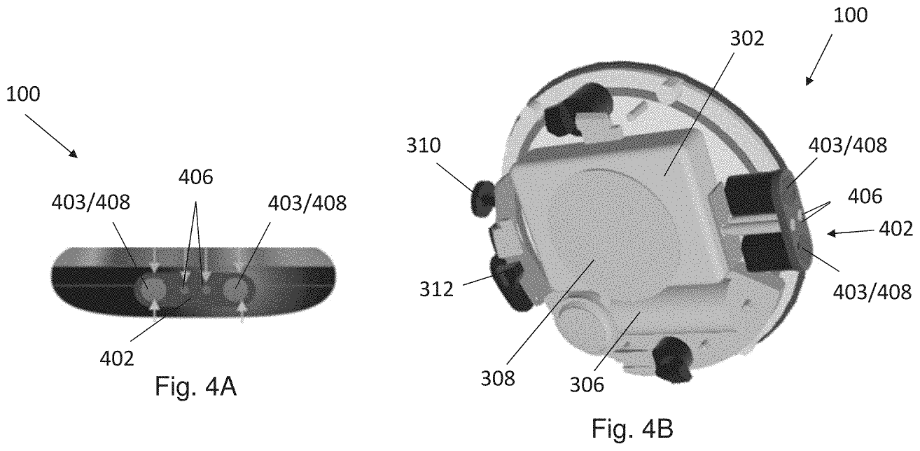

As shown, the device 100 also includes a charging port 106 which allows electrical energy to be transmitted to a battery inside the housing 101 so as to allow the battery to be recharged. This charging port 106 is preferably implemented with a magnetic arrangement that will be described in further detail below with reference to FIGS. 4A and 4B. In this way the charging port 106 may be attracted to any Ferro-magnetic surface, including a charger adaptor which has a ferro-magnetic surface or magnetic arrangement. The charging port 106 may also allow the device 100 to be magnetically attracted and engaged to a ferro-magnetic surface of a bench, table, working surface or musical instrument. This is advantageous as many musical instruments may have metallic or ferro-magnetic surfaces which can allow the device 100 to be quickly engaged to the instruments by use of magnetic attraction, or alternatively by the simple placement and securing of a ferro-magnetic piece on the instrument to which the magnetic arrangement can be attracted to.

In this example embodiment, the electronic device 100 is also arranged to be releasably engaged to a portable cradle 110 which will in turn allow the electronic device 100 to be worn by a user or otherwise engaged to a user or equipment. As shown, the housing 101 uses a releasable engagement arrangement to engage the electronic device 100 to a portable cradle 110 which includes a track and tooth arrangement arranged to allow a track 112 on the electronic device housing 101 to be rotated into a tooth or elevated portion 114 on the cradle 110 such that the cradle 110 can then be engaged to the device housing 101. Similarly, the device 100 can be rotated in the opposite direction from the cradle 110 to release the tooth 114 from the housing 101 so as to release the device 100 from the portable cradle 110.

In this example, the portable cradle 110 includes a wearable arrangement which in this example is a pair of lugs 116 that can be fitted with a strap so as to turn the electronic device 100 into a watch that can be worn on a user's wrist or arms, or otherwise be strapped to a limb of an object or a person such as a bag or musical instrument. In turn, the device 100 can operate as a smart watch as well as to provide various smart device functions to the user, including time, date, alarm functions, schedulers, sound recording, sound/music player, video player, navigational aid or GPS guidance, games, messaging or emails, telephone/teleconferencing, movement tracking or any other smart watch functions, as well as musical related functions, such as playing and recording of music, metronome function (providing a continuous indicator which follows a specific beat rate, either visual, audio or tactile or any one or more thereof), display of wave forms relating to sound, sound meter etc.

Alternatively, the housing 101 may also use another example of an engagement mechanism to engage the device 100 to the portable cradle 110. Other forms of mechanical engagement, such as by snap on type arrangements or magnetic arrangements may also be implemented to engage the housing 101 to the cradle 110. Additionally, the portable cradle 110 may also have different features, including an additional battery for additional power reserve, or may have different wearable arrangements, such as:
other forms of lugs to fit different types of straps;
single sided lugs so as to fit a necklace such that the device can be worn around the neck of a user;
conduits, hooks or clips such that the device can be clipped onto clothing of a user;
hands-free arrangements such that the cradle may secure the device to a piece of equipment or windshield of a vehicle; or
the cradle may also be integrally formed with an item of clothing or accessory, such as gloves, straps, harnesses, arm guards such that the device can effectively be worn integrally with the item of clothing or accessory.

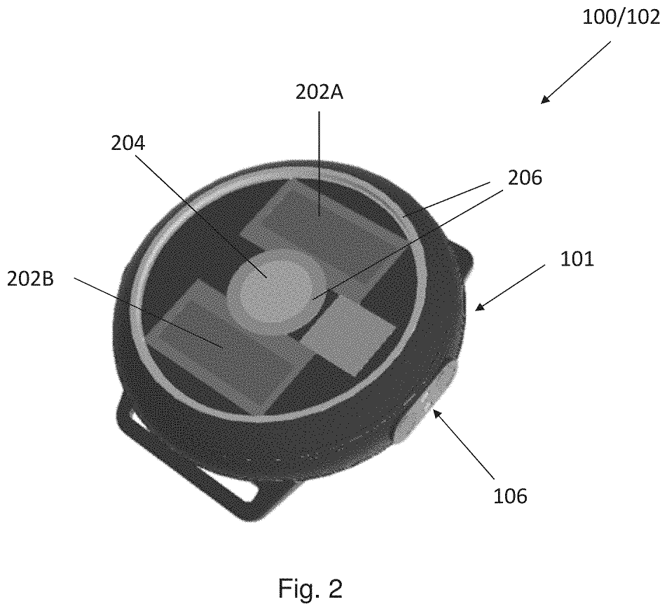

With reference to FIG. 2, there is illustrated an example embodiment of the electronic device 100 of FIG. 1, wherein the interface crystal 108 is removed from the illustration to show the interface 102 of the device 100 in further details.

As shown, the screen and lights layout of the device 100 is behind the interface crystal 108 which is preferably a transparent layer or film made of glass or plastic or any suitable materials to protect the screen (202A, 202B) and lights 204 within the interface.

In this example, the device 100 has a pair of screens 202A and 202B being disposed on a top half and a bottom half of the device 100. This is advantageous in that the screen pair (202A, 202B) can display different information to a user whilst enhancing various functionalities by use of a dual screen (top/bottom) layout. Moreover, the device 100 also has an indicator light 204 disposed in a centre portion of the interface 102 to separate the two screens (202A, 202B). This indicator light 204 can operate as an on/off indicator as well as to provide various signals. Preferably, when the device 100 is in the metronome function, the light 204 can flash so as to follow a desired beat rate, and thus providing a visual indication for a musician to follow whilst they play their instrument as well as an audio sound signal of a desired beat rate.

Additionally, in some example embodiments, the metronome function is also partially or entirely implemented with electronic hardware so as to physically vibrate or shake the device 100 at a desired beat rate as well as to play an optional sound beat. Preferably, the vibrations are created by electronically controlling a vibrator motor unit, such as those found in mobile phones or toys and can be controlled by the processor (CPU) of the device 100 to vibrate in accordance with a particular rate or intensity so as to provide the metronome function. The processor could also operate the vibration motors to be in sync with the light 204 so as to provide the metronome function such that the metronome is both visual and tactile to the user, and if desired an audio beat can also be played. This is particularly advantageous as musicians may operate their instrument by feel, and a tactile response from the vibration motor of the device 100 can assist musicians to play in accordance with a particular beat.

In some embodiments, the annular edges 206 of the crystal 108 and centre light 204 are optically connected and may be lit up by a single or multiple light sources such as an LED arrangement placed on a printed circuit board (PCB) within the housing 101. This has an added advantage of improving the user interface by making it more attractive to the user. Furthermore, the lighting can also be responsive to sound or music and thus provided an attractive lighting arrangement when placed in a suitable location so as to complement the user's musical activities.

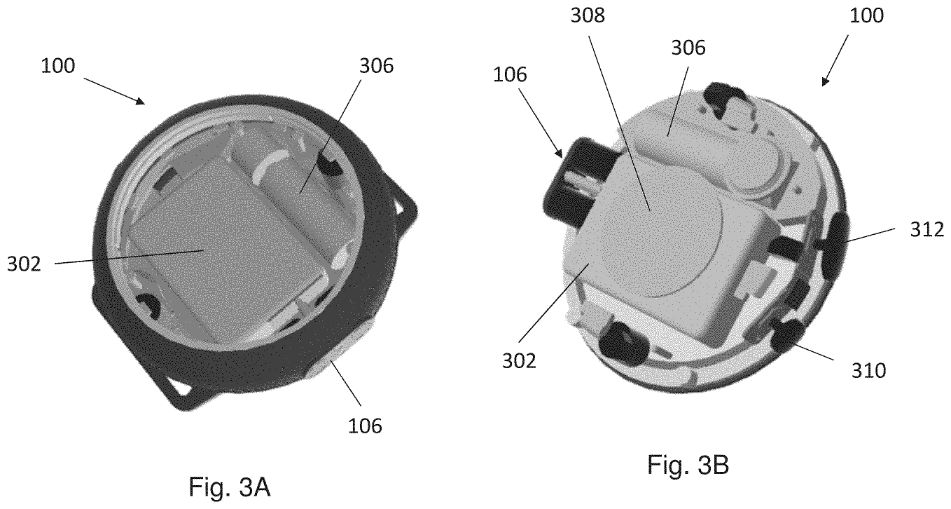

With reference to FIGS. 3A and 3B, there is illustrated an example embodiment of the electronic device 100 of FIG. 1, wherein the screens (202A, 202B), light layout (204) and the bottom cover are removed from the illustration to show the internal components of the device 100 in further details.

As shown in FIG. 3A, a battery 302 is disposed at the centre portion of the device 100. The battery 302 is connected to the charging port 106 via a PCB to receive electrical energy transmitted from the charging port 106 so as to recharge the battery 302. In this example, there is also a vibration sensor 306, which is adjacent to the battery 302, operably connected to a PCB for detecting and measuring the vibration generated from a vibration source.

In this example, the rechargeable battery 302 is preferably a lithium-ion or a lithium-ion polymer battery. It can be appreciated that other rechargeable batteries such as lead-acid, nickel-cadmium and nickel-metal hydride batteries may also be used. This is advantageous as the device 100 can be operated without an external power source, and therefore the user may carry the device 100 around easily.

The vibration sensor 306 may be an electromechanical transducer. In one example, the transducer may be in the form of a microphone. In this example, the transducer is arranged to receive a vibration such as a musical note generated from a musical instrument and converts the vibration into an electrical signal for a digital signal processor (DSP) to process. In turn, the DSP generates a useful signal that is representable of the characteristics of the note such as a frequency of the note or a rhythmic scale of the note etc. to the user. The signal may then be processed by a central processor (CPU) so as to present useful digital information to the user, or can be stored, transmitted for further processing by the CPU or another digital device.

As shown in FIG. 3B, the device 100 includes a speaker 308 being arranged at the bottom of the battery 302 for playing sound or music loaded in the memory of the device 100. The device 100 includes a pair of switches (310, 312) in the form of buttons for manipulating the contents to be displayed on the screens. In this example, the device includes a circular button 310 and an elliptical button 312 operably connected to a PCB, although other shapes and/or configurations of the buttons are also possible. Preferably, the two buttons (310, 312) are arranged to perform different functions. In one example, the circular button 310 may be used to switch between different screen contents whereas the elliptical button 312 may be used to select a specific function on the screen.

As shown in FIG. 3A, the electronic components are placed on a PCB. The PCB may also include a CPU to process digital signals or data into computing data for transmission, storage, or further processing. In one example, the processor may be arranged to process data transmitted between the device 100 and an external electronic device such as a mobile phone, a laptop and the like. In another example, the processor may be arranged to operate the device 100. The processor may provide at least one executable command for storing, editing, or deleting information. In further example, the processor may be arranged to perform various IoT and/or smart functions such as navigational aid or GPS guidance, messaging or emails, or through a communication gateway, functions relating to telecommunications via 4G or LTE, etc. In this embodiment, the processor therefore provides various functionalities for the user including tuning, metronome, and various smart device functions such as providing games, time, selection of left-handed or right-handed etc.

In some example embodiments, the PCB may also be implemented with a vibration motor which can be controlled by the processor to vibrate at a particular rate and/or intensity. This is particularly useful when the motor is operated in conjunction with the metronome function of the device 100 as the vibration from the vibration motor can be controlled to operate at a particular beat rate for the user. Moreover, when the device 100 is engaged to the musical instrument, such as by magnetic attraction to a ferromagnetic portion of a musical instrument, or an added ferromagnetic plate or bracket of the musical instrument, the device's 100 vibrations may also gently vibrate the instrument slightly (or its intensity may be selected by the musician). This is particularly useful as the musician that operates the metronome function may be able to feel the vibration at a specific beat rate on his or her instrument, which in turn makes it easier for them to play music to a particular beat rate as desired.

In some example implementations, the vibration motor may interfere with the vibration sensor of the device 100 since the vibration motor is itself a vibration source. However, in most examples, the vibration motor's vibration is of a wave form, amplitude and range that may be significantly different to sound related vibrations to which the vibration sensor would normally operate when working with sound or music. Nonetheless, to ensure accuracy in the operation of the vibration sensor, the processor may also be arranged to perform an error correction on the vibration data obtained from the vibration sensor when the vibration motor is operating. This can be performed, in one example, by knowing what the vibration waveform characteristics are as emitted from the vibration motor, which would be pre-determined as such characteristics are pre-known during the design and implementation of the device 100 or it may also be detected by an on board sensor. Once these characteristics are known, these characteristics can be deducted from the signals obtained from the vibration sensors to perform an error correction as needed resulting in the correct rate of vibrations to be measured by the device 100.

As shown in FIGS. 4A and 4B, there is illustrated an embodiment of the charging port 402 of the device 100. As shown, the charging port 402 is provided on one side of the device 100. In one example, the charging port 402 may be provided on the opposite side of the pair of switches 310 and 312, although it is appreciated that the charging port 402 configured on any other sides of the device 100 is also possible. Preferably, the charging port 402 is implemented with a magnetic arrangement 403. This is advantageous as the device 100 may be engaged to a charger or socket head of a charger that has a complementary magnetic arrangement so as to recharge the battery 302 or engaged to a musical instrument to perform functions such as tuning, sound/music recording etc.

As shown in FIG. 4A, the device 100 includes a charging port 402 arranged on one side of the device 100. In one example, the charging port 402 includes four metallic portions being arranged on the same plane. The centre of the charging port 402 includes two metallic conduits 406 connected to the battery 302 through the PCB. The metallic conduits 406 may be made of any metals that have good electrical conductivity such as copper, silver, gold, gold-plated copper and the like so as to allow electrical energy to be transmitted to the battery 302.

In this example, the conduits 406 are arranged in a horizontal orientation as shown in FIG. 4A. Alternatively, the conduits 406 may be arranged in a vertical orientation as shown in FIG. 4B. In both of these examples, there is a pair of magnets 408 being arranged adjacent to the conduits 406 of the charging port 402. In some examples, the magnets 408 may be electrically connected to the conduits 406 and the battery 302 through the PCB so as to provide an additional electrically conduit for the transmission of electrical energy to and from the battery 302.

The pair of magnets 408 may be placed in a specific orientation such as North/South, North/North or South/South orientation so that a complementary charger or socket head of a charger can be specifically designed to couple with the charging port 402 and where the charger is not complementary, the charger would not be coupled with the charging port 402 due to magnetic repulsion. In addition, the pair of magnets 408 may be connected with the PCB, with a specific circuit detection mechanism such that when the pair of magnets 408 are engaged with a metallic surface of a musical instrument, a table, a bench, a desk or an accessory, a closed circuit is formed between the metallic surface and the magnets. This in turn generates an electrical signal to the processor and may trigger the tuning function of the device 100. This may be advantageous as a user can simply place the device 100 on the surface as mentioned to operate the device 100 at once and remove it once finish the operation.

FIG. 4B illustrates another embodiment of FIG. 4A, wherein the bottom cover of the device 100 is removed from the illustration to show the internal components of the device 100. As shown, the device 100 includes a battery 302, preferably a rechargeable battery 302 at the centre portion of the device 100. The device also includes a vibration sensor 306 such as an electromechanical transducer being disposed adjacent to the battery 302. The device 100 further includes a pair of switches (310, 312) in the form of a circular button 310 and an elliptical button 312 on one side of the device. In this example, the charging port 402 is arranged on the side opposite to the pair of buttons (310, 312).

As shown in FIG. 4B, the charging port 402 includes a pair of metallic conduits 406 arranged at the centre of the charging port 402. In this example, the conduits 406 are vertically arranged and are connected to the battery 302 via the PCB. The charging port 402 includes a pair of magnets 408 adjacent to the conduits 406. Although the magnets 408 in the present example are cylindrical, it can be appreciated that other shapes are also possible. The magnets 408 are arranged in a way that the poles facing outwards are different. That is, one magnet with its North Pole facing outwards whereas the other magnet with its South Pole facing outwards, and vice versa. In this regard, the charger with the complementary magnet arrangement may be used to couple with the charging port 402 for battery charging. With the use of the magnetic arrangement 403, it is advantageous that the device 100 can be connected to the charger easily without a tedious physical manipulation of a wire/socket as magnetic attraction will see that the charging port is connected to the socket correctly.

In one example, the magnets 408 may be connected to the conduits 406 and the battery 302 through a plurality of PCBs. Upon charging the battery 302, the conduits 406 and the magnets 408 are electrically and magnetically engaged with a power bank such as a charger complementary to the magnetic arrangement 403. In turn, the electrical energy from the charger is transmitted to the battery 302 through the conduits 406 and the magnets 408. This is an added advantage as the charging rate may be enhanced and therefore reducing the time to fully charge the battery 302. With the same charging port arrangement, the charging port 402 can also form a closed circuit with the metallic surface of the musical instrument. In turn, it may generate an electrical signal which is transmitted through the magnets 408 to the processor, triggering the tuner mode of the device 100.

In another example, the magnets 408 and the conduits 406 may be separately connected to their respective PCBs. In this example, upon charging, the magnets 408 are solely used for engaging to the complementary charger through a magnetic attraction whereas only the conduits 406 form a closed circuit with the charger to transmit electrical energy to the battery 302. Nonetheless, with this charging port arrangement, the tuner mode of the device 100 may also be triggered upon engaging the device 100 magnetically to the metallic surface of the musical instrument.

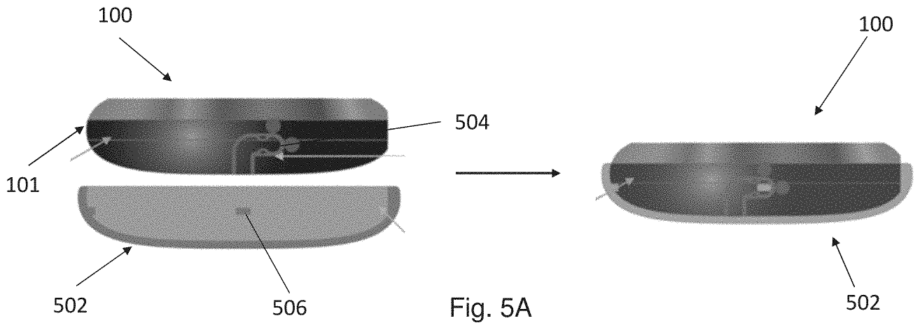

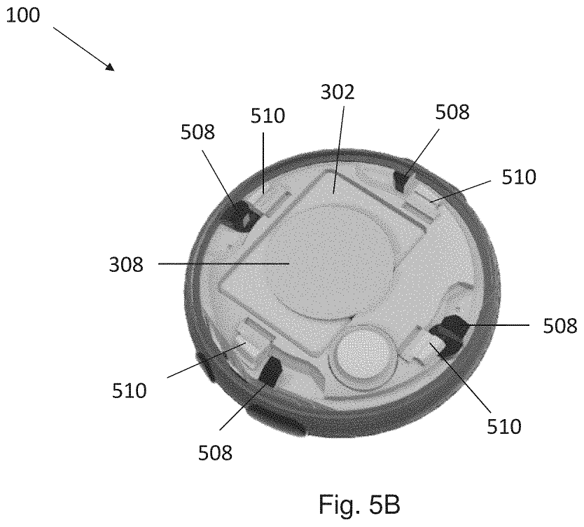

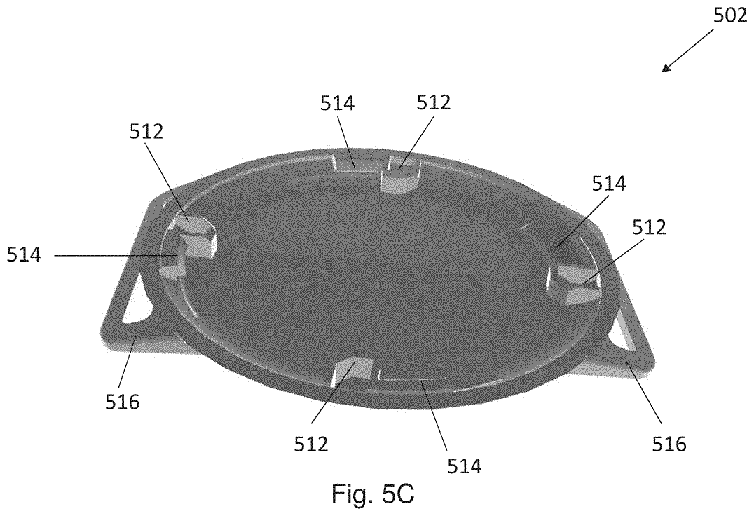

Embodiments of the present invention may be advantageous as a user may readily turn the device 100 into a portable or wearable form by use of a releasable engagement mechanism to engage the device 100 and a cradle arrangement 502. FIGS. 5A to 5C illustrate an embodiment of the device 100 that releasably engages with a cradle arrangement 502 so as to allow the device 100 to be worn by the user, attach to a body part of the user or engage with an equipment.

As shown, the releasable engagement mechanism includes two portions, in which at least one coupling member 504 is disposed within the housing 101 of the device 100 and at least one complementary counterpart 506 is disposed on the cradle 502. In this example, at least one hollow coupling member 506 in the form of a track is disposed within the housing 101 of the device 100. Preferably, the track is in the form of a bayonet sleeve. Complementarily, at least one tooth/protrusion member 506 is disposed on the cradle 502 which in turn engages and/or disengages with the at least one track arranged within the device 100 through a twistable or rotation action.

In one example, the device 100 may include four bayonet sleeves 504 arranged radially with equally spacing within the housing 101 of device 100 so as to engage with the four complementary protrusions 506, preferably in the form of bayonet insert, through a twistable/rotation action. In turn, the device 100 may also be disengaged from the cradle 502 simply by twisting/rotating the device 100 in the opposite direction.

In another example, the device 100 may include at least one coupling member which is in the form of a tooth member for engaging with the complementary track member provided on the cradle. As shown in FIG. 5B, the device 100 includes four tooth members 508 arranged radially with equally spacing. Each of the tooth members 508 may include a polygonal tooth such as a trapezoid tooth and a clip member 510 being disposed adjacent thereto as a pair so as to engage with the complementary members (512, 514) disposed on the cradle 502 as shown in FIG. 5C. Upon engagement, the four polygonal teeth 508 fit into the complementary polygonal track members 512 on the cradle 502 whereas at the same time the four clip members 510 snap on the longitudinal track members 514 which therefore the device 100 is secured on the cradle 502 without a twistable/rotation action.

In some examples, the cradle 502 may include at least one magnetic arrangement that is complementary to the magnets provided in the device so as to allow the device 100 to engage with the cradle 502 simply through a magnetic attraction or in combination with the engagement mechanisms as described above. The cradle 502 may also include additional features such as an additional battery for providing a back-up power to the device 100 or different wearable arrangements for the users.

In one example, the cradle 502 may include a pair of lugs 516 such as the one as shown in FIG. 5C, for detachably receiving at least a pair of straps so as to allow the device 100 to be worn on the users' wrist or arms like a wrist watch, or otherwise be strapped to a limb of an object such as a bag or musical instrument. Preferably, the straps are in the form of a pair of adjustable and symmetrical bands similar to watch bands. The bands may be made of rubber, nylon, metals such as stainless steel, or leather etc. In turn, the device 100 may be operated as a smart watch as well as to provide various smart device functions to the user, such as time, date, alarm functions, schedulers, sound recording, sound/music player and the like, as well as musical related functions, such as playing and recording of music, metronome function, display of wave forms relating to sound, sound meter etc.

Referring to FIGS. 6A to 6H, there is shown a number of examples screenshots 600 of the interface of the device 100 when in use. As shown in these figures, the device is able to provide the user with a number of functions, including:
metronome that allows the user to play or practise a song under a regular pulse, the user may play songs loaded in the memory of the device directly through the device or an App on an external device, select time signatures, subdivisions, and accents of the songs, select vibrations waveform and light colors during the play so as to enhance the enjoyment;
tuner which allows the user to tune or manipulate the musical instruments regularly during practice or performance, the tuning function of the device is activated once the device is placed on a musical instrument, the device may be used for turning different string musical instruments such as guitar, bass guitar and violin in a noisy environment against an adjustable reference frequency from such as 432 Hz to 440 Hz, the device may also provide a colored LED feedback for accurate turning;
multi-sync which allows the user to synchronize different songs or Apps from various external devices to the device for enjoyment, the device may be connected up to 30 or more external devices whilst any of the connected external device may be paused/stopped without affecting the others;
watch, the device may be turned into a watch after being engaged with a cradle arrangement as mentioned, the watch may provide various smart functions such as automatic time zone setup, wakeup alarm, stopwatch/timer, receive notifications such as messages, calendar information, call information from smartphone, the watch may also provide other functions like sound recording, sound/music player, video player, navigational aid or GPS guidance as well as movement tracking;
rhythm games, the device may be loaded with various rhythm games, for example, the games may require the user to play specific notes in accordance with those shown on the device or even a section of a song, for playing, scoring or training purpose; and
sound level meter, the device may be used to detect or measure sound level of the surrounding area with a dB alarm function, the device also provide a continuous monitoring function.

With reference to FIG. 6A, there is shown an example screenshot 602 showing an example watch function of the device 100. In this example, the device is operating in the watch and multi-sync functions with the interface showing a current time 602A on the top half as well as the battery level and the number of external device connected to the device 100 via Bluetooth 602B on the bottom half. These functions provide the user the battery status and the device connection status on a separate screen and are advantageous as the icon size can be larger, making the device more user-friendly.

With reference to FIG. 6B, there is shown an example screenshot 604 showing an example metronome of the device 100. In this example, the device is operating in metronome function with the interface showing the number of loaded songs 604A and selected subdivisions 604B as well as the vibration waveform 604C. The user may transfer the songs from an external device such as a mobile phone or a digital music player to the device 100 and play/pause/stop the songs directly through the device 100 or through an App on the external device. This is advantageous as in turn the user may have a wide range of song lists by simply loading the songs from a song database on the external device into the device 100. In addition, the central light layout 604D may also provide rhythmic lighting effect in response to the vibration waveform 604C showing on the bottom half of the interface.

With reference to FIG. 6C, there is shown an example screenshot 606 showing an example tuning function of the device 100. In this example, the device is operating in the tuning function for a guitar with the interface showing the reference frequency of 440 Hz and a message reminding the user that the reference frequency can be changed via a twisting action. The way to change the reference frequency is advantageous as the user may change the reference frequency instantly by simply twisting the arm once the user finishes tuning the guitar at one particular frequency. In addition, when the note frequency of the guitar meets the reference frequency, the central light layout or the annular edge of the device may light up to feedback the accurate tuning.

With reference to FIG. 6D, there is shown an example screenshot 608 showing an example sound level meter of the device 100. In this example, the device is operating in the dB alarm function with the interface showing the maximum sound level is set at 120 dB with the alarm is under an off state whilst the alarm may be turn on by the user through a twisting action of his/her arm. The alarm is particularly useful when the user plays the instrument in a quiet environment where it is ranged to keep the volume to a minimum.

With reference to FIG. 6E, there is shown an example screenshot 610 showing an example watch function of the device 100. In this example, the device is operating in wakeup alarm function with the interface showing the alarm is set to activate at 8:30 on Sunday, Monday and Tuesday. The alarm may be turned off by the user through a twisting action. In addition, when the alarm is activated, the device may provide rhythmic lighting effect at the central light layout or the annular edge of the device.

With reference to FIGS. 6F and 6G, there is shown an example screenshots 612 and 614 showing of an example watch function of the device. In this example, the device is operating in stopwatch (FIG. 6F) and timer (FIG. 6G) functions with the interface showing the time on the top half. In order to use the stopwatch or the timer function, the user may simply tap the bottom half of the device (as shown in FIGS. 6F and 6G) to start the stopwatch or set a starting time for the timer. The stopwatch/timer function is advantageous as the user may know whether he is playing a song with an appropriate speed. In addition, the user may pause/stop/reset the stopwatch and timer by using the buttons such as those as mentioned in FIG. 3.

With reference to FIG. 6H, there is shown an example screenshot 616 showing of an example watch function of the device. In this example, the device is operating in left/right handed selection function with the interface showing that the screen may be rotated by simply rotating the device by 180 degrees. This is advantageous as the user does not need to rotate his arm when sharing the device information such as time, messages etc. to the others. In addition, the device may play a sound or a voice message indicating that the screen has been rotated so as to serve as a reminder to the user.

It should be appreciated by a person skilled in the art that the device 100 may be implemented in certain embodiments to have one or multiple functions as mentioned herein. Thus the device 100, may have the tuner function only, whilst other devices 100, may be implemented to have the metronome or sound meter function only, whilst other example devices 100 may have one or more other functions as listed herein. Different functions may be implemented as desired by the manufacturer based on commercial and economic decisions, although in a preferred example, the device 100 may be implemented with the tuner function, metronome function, sound meter function and other electronic functions and other smart watch/IoT functions so as to provide a comprehensive and multi-function device for the user.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An electronic device comprising:
a vibration sensor arranged to detect and measure a vibration emitted from a vibration source;
a housing arranged to house the vibration sensor; wherein the housing includes an engagement mechanism to engage the housing to a portable cradle.

2. The electronic device in accordance with claim 1, wherein the portable cradle is arranged to be engaged with a user or an object.

3. The electronic device in accordance with claim 2, wherein the portable cradle is arranged to be worn by the user.

4. The electronic device in accordance with claim 2, wherein the portable cradle includes at least one adjustable strap detachably connected thereto.

5. The electronic device in accordance with claim 1, wherein the portable cradle includes at least one protrusion to engage the engagement mechanism of the housing.

6. The electronic device in accordance with claim 1, wherein the portable cradle includes at least one magnet to engage the engagement mechanism of the housing.

7. The electronic device in accordance with claim 1, wherein the engagement mechanism includes a rig mechanism, at least one magnet or a combination thereof for engaging the housing to the portable cradle.

8. The electronic device in accordance with claim 7, wherein the rig mechanism includes at least one hallow coupling member for engaging the housing to the portable cradle.

9. The electronic device in accordance with claim 8, wherein the at least one hallow coupling member is a bayonet sleeve.

10. The electronic device in accordance with claim 1, wherein the housing is releasably engaged to the portable cradle through a twistable action between the rig mechanism of the housing and the at least one protrusion of the portable cradle.

11. The electronic device in accordance with claim 1, wherein the housing is releasably engaged to the portable cradle through a magnetic interaction between the at least one magnet of the housing and the at least one magnet of the portable cradle.

12. The electronic device in accordance with claim 1, wherein the housing is releasably engaged to the portable cradle through a combination of the twistable/rotation action and the magnetic interaction.

13. The electronic device in accordance with claim 1, wherein the device further includes at least two pieces of magnets being arranged within the housing.

14. The electronic device in accordance with claim 13, wherein the at least two pieces of magnets are arranged to releasably secure the device to a metallic portion of a musical instrument.

15. The electronic device of claim 14, wherein the at least two pieces of magnets are further arranged to be integrated within a portion of a charging port of the device.

16. The electronic device in accordance with claim 13, wherein at least one of the magnets is arranged with the north pole facing outside and at least one of the magnets is arranged with the south pole facing outside.

17. The electronic device in accordance with claim 1, wherein the vibration sensor is an electromechanical transducer.

18. (canceled)

19. The electronic device in accordance with claim 1, wherein the vibration is a musical note.

20. The electronic device in accordance with claim 1, wherein the vibration source is a musical instrument.

21. (canceled)

22. The electronic device in accordance with claim 1, wherein the device further includes at least one indicator to reflect the accuracy of the detection and measurement.

23. (canceled)

24. The electronic device in accordance with claim 1, wherein the device is further arranged to measure a sound level of the surroundings.

25. The electronic device in accordance with claim 1, wherein the device is further arranged to operate as a metronome.

26. The electronic device in accordance with claim 25, wherein the metronome is arranged to be provided by visual means, audio means, tactile means or any one or more thereof.

27. The electronic device in accordance with claim 25, wherein the device includes a vibration motor arranged to vibrate at a specific rate.

28. The electronic device in accordance with claim 27, wherein the specific rate is determined by a processor arranged to apply an error correction procedure to measure the vibration emitted from the vibration source.

29. (canceled)

30. The electronic device in accordance with claim 28, wherein the error correction procedure includes the steps of determining the vibrations of the vibration motor and deducting the vibrations from the measured vibrations emitted from the vibration source.

31. The electronic device in accordance with claim 1, wherein the device is arranged to perform one or more of the following functions:
selecting time signature, subdivisions, accents, vibration waveforms, and light colors; or
operating rhythm games.

32. (canceled)

33. (canceled)

34. A charge port for an electronic device comprising:
a conductive conduit arrangement arranged to connect a battery with an external power source; and
a magnetic arrangement disposed adjacent to the conductive conduit arrangement; wherein the magnetic arrangement is arranged to assist in the engagement of the external power source to the conductive conduit arrangement.

35. A The charge port in accordance with claim 34, wherein the external power source is engaged to the conductive conduit arrangement via a socket head having a ferromagnetic surface.

36. A The charge port in accordance with claim 34, wherein the magnetic arrangement includes a pair of magnets.

37. A The charge port in accordance with claim 36, wherein the socket head has a pair of magnetic members to complement the pair of magnets of the magnetic arrangement.

38. A The charge port in accordance with claim 37, wherein the pair of magnets of the magnetic arrangement is arranged with a predetermined polarity configuration to complement the magnetic members of the socket head.

39. A The charge port in accordance with claim 34, wherein the charge port is used to engage the electronic device to a or ferromagnetic work surface, equipment or musical instrument.

40. A The charge port in accordance with claim 39, wherein the charge port uses the magnetic arrangement to magnetically engage the electronic device to the work surface, equipment or musical instrument.

41. A portable cradle for an electronic device comprising:
a cavity arranged to receive the electronic device, wherein the cavity includes a locking mechanism arranged to removably engage or disengage with the electronic device; and
engagement means arranged to engage the cradle to an object or person.

42. The portable cradle in accordance with claim 41, wherein the engagement means include one or more lugs, each arranged to receive a strap for wearing or securing with the object or person.

43. The portable cradle in accordance with claim 41, wherein the locking mechanism is a slot arranged to receive a protruding member of the electronic device to engage the device to the cradle.

44. The portable cradle in accordance with claim 43, wherein the slot and the protruding member are locked by rotating the protruding member around a shoulder of the slot.

45. The portable cradle in accordance with claim 44, wherein the slot and the protruding member are unlocked by rotating the protruding member around the shoulder of the slot in a direction opposite to locking the slot and the protruding member.

46. The portable cradle in accordance with claim 41, wherein the cavity includes one or more magnetic members arranged to attract a ferromagnetic surface of the electronic device to engage the cradle with the electronic device.

47. The portable cradle in accordance with claim 41, wherein the cavity and the electronic device includes a snap-fit arrangement arranged to engage the cradle to the electronic device.
